(19) United States
(12) Patent Application Publication
(10) Pub. No.: US 2010/0121545 A1
(43) Pub. Date: May 13, 2010

(54) METHOD FOR OPERATING A TRANSMISSION

(75) Inventor: Roland Mair, Tettnang (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/596,220

(22) PCT Filed: Apr. 3, 2008
(86) PCT No.: PCT/EP08/53974

§ 371 Date: Oct. 16, 2009

(30) Foreign Application Priority Data
Apr. 28, 2007 (DE) 10 2007 020 119.4

(51) Int. Cl. G06F 19/00

(52) U.S. Cl. 701/60

(57) ABSTRACT

The invention relates to a method for operating a transmission, especially an automatic transmission, comprising a dry starting clutch. Said starting clutch is especially configured as a friction clutch and a characteristic value is determined during operation in defined operating points, said value being indicative of the state of wear of the starting clutch. The method according to the invention is characterized by comparing a newly determined characteristic value with a characteristic value previously determined in a previous operating point. If the newly determined characteristic value deviates from the previously determined characteristic value to such an extent that it suggests a reduced wear of the starting clutch, it is assumed that the starting clutch has been replaced and a wear indicator of the starting clutch is reset in a defined manner.

This application is a National Stage completion of PCT/EP2008/053974 filed Apr. 3, 2008, which claims priority from German patent application serial no. 10 2007 020 119.4 filed Apr. 28, 2007.

### FIELD OF THE INVENTION

The invention concerns a method for operating a transmission.

### BACKGROUND OF THE INVENTION

Vehicles need transmissions to convert torque and rotational speed. It is the task of a transmission to convert the pull force which is being generated by a drive unit. Regarding this invention, all transmissions are included under this term, especially the configuration of a friction clutch being operated as a starting clutch, if during the operation and under pre-defined operational points, the starting clutch characteristic values can be determined, they can provide details about the wear condition of the starting clutch. That includes especially the automatic transmissions which provide an automated gear change or automatic gear change.

A method is known from DE 196 39 296 C1 in which a starting clutch wear condition can be determined. In the meaning of a wear counter, the lost energy due to the clutch slippage is continuously added whereby the summed value is compared to a predetermined value which frequently shows the total wear of the clutch. At that time, when the wear counter or the summed value, respectively, exceeds a predetermined value, replacement of the starting clutch or the clutch friction linings will be initiated as part of an inspection.

Later, once the starting clutch is replaced or the friction linings are replaced, respectively, based on the values of the wear counter, the wear counter needs to be reset at that time. It will be performed by use of a diagnostic tool which is connected to a transmission control unit.

Therefore, the resetting of the wear counter represents an additional operating step and a risk exists that resetting of the wear counter of the starting clutch will be forgotten during clutch replacement or replacement of the friction linings.

### SUMMARY OF THE INVENTION

On that basis, this invention targets that problem by establishing a novelty method of operating a transmission.

In this present invention, a newly calculated characteristic value, which provides the details of the wear condition of a starting clutch, is compared to a previously established operating point characteristic value and then, if the newly calculated characteristic value deviates significantly from the previously predetermined characteristic value, so that the result shows a reduced wear condition of the starting clutch, the condition is assumed as a replaced starting clutch and the wear counter of the starting clutch is reset in a defined manner.

In the present invention, the reset of the wear counter of the starting clutch in a transmission, after its replacement or the replacement of the friction linings, respectively, is performed automatically under a condition when a newly calculated characteristic value of the starting clutch, which represents its current wear condition, deviates significantly from the previously predetermined characteristic value, resulting in and showing a lesser wear condition, the situation is assumed as a replaced starting clutch or replaced friction linings, respectively, and the wear counter of the starting clutch is reset in a defined manner.

Hereby, a separate reset of the wear counter, by means of a diagnostic tool, can be eliminated so that there is no longer any risk of failing to reset of the wear counter.

Preferably, at the time when the newly calculated characteristic value deviates from the previously, predetermined characteristic value by more than the first limiting set point value, it is assumed that the starting clutch has been replaced with a new starting clutch whereby, at this time, the wear counter is reset in a manner that its value corresponds to that of a new starting clutch. However, when the newly calculated characteristic value deviates from the previously predetermined characteristic value, in the direction of a lesser wear condition, less than the first limiting set point value but more than the second limiting set point value, it is assumed that the starting clutch has been replaced with a used starting clutch, whereby the wear counter is reset in a manner that its value will correspond with that of a used starting clutch.

### BRIEF DESCRIPTION OF THE DRAWINGS

Preferred embodiments of this invention are presented in the following description. The embodiments of this invention, without being limited through it, are explained further in the drawing. Hereby is:

FIG. 1 a schematic flow chart to further clarify the inventive method for operating a transmission.

### DETAILED DESCRIPTION OF THE PREFERRED EMBODIMENTS

This present invention relates to a method of operating a transmission having a starting clutch. Such a transmission is especially known as an automatic transmission, comprising automatic or automated gear changes, whereby such a starting clutch, in particular, is a dry clutch designed as a friction clutch.

During the operation, a characteristic value of the starting clutch will be calculated, within predetermined operating points, which identifies the wear condition of the clutch.

Preferably, this characteristic value is a position of the starting clutch at which it is locked. Depending on the respective wear condition, the locked position of the starting will change whereby the locked position, under increasing wear, will clearly change in only one direction. The calculation of the characteristic value occurs in the locked position of the starting clutch. Therefore, the characteristic value can be determined, as an example, when driving in a gear, or the transmission is in the neutral position and the starting clutch is in a locked position. To ensure a proper calculation of the characteristic value, the starting clutch can also be locked by means of an actuator.

A newly calculated characteristic value, in accordance with this invention, is compared to a previously predetermined operating point characteristic value whereby then, when the newly calculated characteristic value deviates significantly from the previously calculated characteristic value, showing a lesser wear condition of the starting clutch, it is assumed that the starting clutch has been replaced or the friction linings have been replaced, respectively. In this case, the wear counter of the starting clutch is reset.

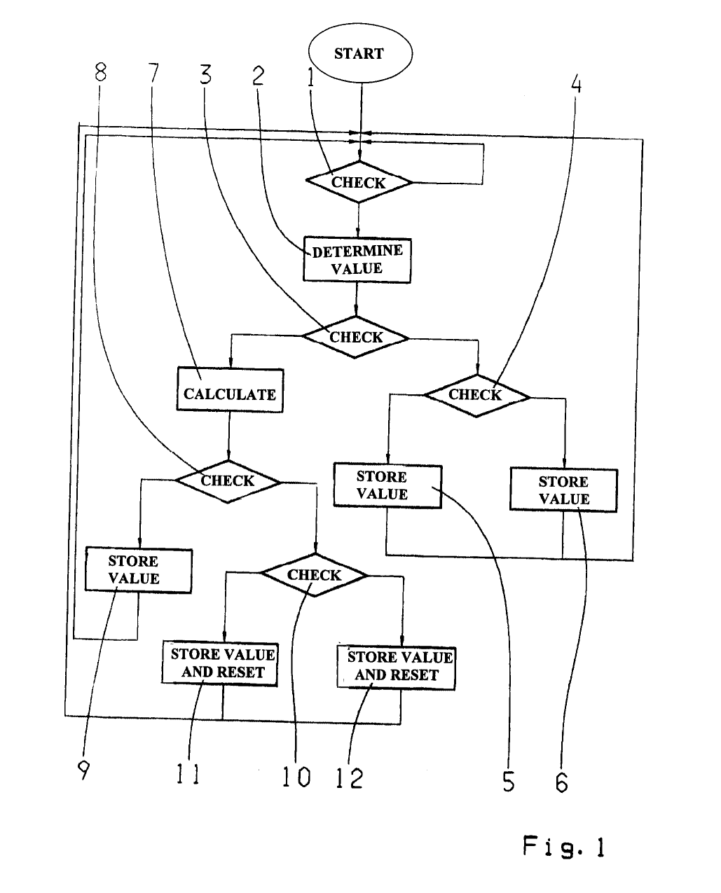

This inventive method is presented in detail with reference to the flow chart in FIG. 1.

In block 1 of the flow chart, a check is performed to determine the presence of a defined operating point by which a characteristic value of the starting clutch, showing its wear condition, can be reliably determined. Herewith, block 1 enables the checking of the transmission input gear rotational speed or motor rotational speed and a determination whether these characteristic values are within a certain range. Alternatively, or in addition, block 1 can also perform a check to determine if the ambient temperature and/or the transmission temperature is within a defined range. Alternatively, or in addition, block 1 enables the checking of the transmission load to be within a defined range.

Only at the point once block 1 determines that the operating criteria are met, block 1 is now branches to block 2 whereby a characteristic value of the wear condition of the starting clutch is newly calculated in block 2. Otherwise, block 1 returns back to before block 1 if conditions are not met.

At the time when block 1 determines the presence of a defined operating point of the starting clutch, a branching of the flow to block 2 occurs in accordance with the flow chart in FIG. 1 whereby, as already being mentioned, the characteristic values of the automatic transmission, which shows its wear condition, is determined in block 2. In this case, it is preferably the locked position of the starting clutch, which is dependent on its wear condition. This locked position can be calculated without special measures since the starting clutch is normally in a locked position, when driving in a gear position and shifting does not occur. For an increase of the safety in calculating the locked position, an actuator is used for switching the automatic transmission into a defined locked position.

It is checked, at the following block 3, if the newly calculated characteristic value deviates significantly from the previously determined characteristic value, if it results in a lesser wear condition of the starting clutch. If the block 3 determines that this is not the case, that the wear condition of the starting clutch actually increases, block 3 will branch to block 4, whereby at block 4 it will be checked if the wear counter of the starting clutch exceeds a predefined value. If that is the case, block 4 will branch to block 5 and a message, which is stored in a transmission control unit, is generated and becomes the basis for an inspection for either replacement or renewal, respectively, of the starting clutch or the friction linings, respectively.

This message for initiating a maintenance inspection at a service center to replace the starting clutch can also be visualized on a display in the cabin. In addition, the newly calculated characteristic value is stored in block 5.

If block 4 instead recognizes that the value of the wear counter is lower than the predefined value, at that time block 4 branches to block 6, whereby in block 6 only the newly calculated characteristic value is stored. From both block 5 and block 6, the flow returns back to block 1.

If block 3 instead recognizes that the newly calculated characteristic value of block 2 significantly deviates from the previously calculated characteristic value so that it results in a lesser wear condition of the starting clutch, it is assumed that replacement of the starting clutch or the friction linings, respectively, occurred and the flow branches to block 7. In block 7 it is calculated to what amount the newly calculated characteristic value deviates from the previously calculated characteristic value.

In the following block 8, it is checked if the newly calculated characteristic value deviates in the direction of a lesser wear condition, in particular, more than the first upper limiting value. If that is the case, it is assumed that the starting clutch was or is replaced with a new starting clutch or its friction linings, respectively, whereby block 8 branches to block 9. At block 9, the wear counter of the starting clutch is reset in a manner so that the value corresponds with the value of a new starting clutch.

However, if block 8 recognizes that the newly calculated characteristic value deviates significantly from the previously calculated characteristic value in a lesser amount than the first upper limiting value, in that case block 8 branches to block 10 whereby it is checked, in block 10, if the newly calculated characteristic value deviates from the previously calculated characteristic value by more than a second, namely lower, limiting value. If block 10 recognizes that being the case, it is assumed that the starting clutch or friction linings are or have been replaced with a used starting clutch. In that case, the flow branches to block 11, whereby in block 11 the wear counter for the starting clutch is reset in a manner so that its value corresponds to that of a used starting clutch.

However, if block 10 recognizes that the newly calculated characteristic value deviates from the previously calculated characteristic value by less than the first, upper limiting value, as well as also by less than the second, lower limiting value, branching of the flow from block 10 to block 12 occurs whereby no resetting of the wear counter of the starting clutch occurs but just storage of the newly calculated characteristic value. Such a storage of the newly calculated characteristic value also occurs in block 9 and block 11. From blocks 9, 11, and 12, the flow branches back from each of said blocks to before block 1.

The resetting of the wear counter in block 11, to a value which corresponds to that of a used starting clutch is accomplished by comparing the calculated characteristic value of block 7 with a corresponding characteristic value of a new starting clutch, i.e., the characteristic value being stored in a transmission control unit. The difference between the characteristic value of a new clutch and the calculated value of a used clutch characteristic value, in block 7, can be used in block 11 for calculating the wear level of a used clutch, accordingly enabling the resetting of the related wear counter.

Therefore, it is an object of the invention to calculate a characteristic value of the starting clutch at predefined operating points, during operation of the vehicle and including its related starting clutch, which provides information about its wear condition. Then, when a newly calculated characteristic value deviates significantly from a previously calculated characteristic value so that the result is a reduced wear condition of the starting clutch, it is assumed that it is caused by a replacement of the starting clutch. In this case, a wear counter of the starting clutch will be reset in a defined manner. The entire method occurs automatically or in an automated mode, respectively, so that no separate work step is necessary, also, the risk of failing to reset the wear counter is eliminated, i.e., during the replacement or exchange of the starting clutch.

### REFERENCE CHARACTERS OF THE DRAWING

1 Block
2 Block
3 Block
4 Block
5 Block
6 Block
7 Block
8 Block
9 Block
10 Block
11 Block
12 Block

1-6. (canceled)

7. A method of operating a transmission having a starting clutch, whereby a characteristic value of the starting clutch, which provides information about the wear condition of the starting clutch, is calculated at defined operating points during the operation of the transmission, the method comprising the steps of:
calculating a new characteristic value,
comparing the new characteristic value with a previously calculated characteristic value, and
if the newly calculated characteristic value deviates significantly from the previously calculated characteristic value such that the deviation indicates a less wear condition of the starting clutch,
assuming that the starting clutch was replaced, and
resetting a wear counter in a defined manner.

8. The method according to claim 7, further comprising the step of, if the newly calculated characteristic value deviates from the previously calculated characteristic value such that the deviation indicates the less wear condition of the starting clutch by more than a first limiting value, assuming that the starting clutch was replaced with a new starting clutch, and resetting the wear counter in a manner so that the characteristic value corresponds to that of the new starting clutch.

9. The method according to claim 7, further comprising the step of that if the newly calculated characteristic value deviates from the previously calculated characteristic value such that the deviation indicates a less wear condition of the starting clutch by less than a first limiting value but more than a second limiting value, assuming that the starting clutch was replaced with a used starting clutch and resetting the wear counter in a manner so that a value of the wear counter corresponds to that of the used starting clutch.

10. The method according to claim 7, further comprising the step of that the characteristic value is solely calculated in the operating points in which at least one of a transmission rotary speed and a motor rotary speed, respectively, match a defined range.

11. The method according to claim 7, further comprising the step of only calculating the characteristic value at the operating points in which at least one of a transmission oil temperature and an ambient temperature match a defined range.

12. The method according to claim 7, further comprising the step of only calculating the characteristic value at the operating points in which a load of the starting clutch matches with a defined range.
